(19) United States
(12) Patent Application Publication
(10) Pub. No.: US 2008/0140420 A1
(43) Pub. Date: Jun. 12, 2008

(54) Remote payment system

(75) Inventor: Yun-Wen Lee, Taoyuan Shien 320 (TW)

Correspondence Address: Haverstock & Owens LLP,, 162 North Wolfe Road, Sunnyvale, CA, 94086, US

(73) Assignee: Delta Electronics, Inc.

(21) Appl. No.: 11/895,357

(22) Filed: Aug. 24, 2007

(30) Foreign Application Priority Data
Dec. 8, 2006 (TW) 095146179

(51) Int. Cl. G10L 11/00

(52) U.S. Cl. 704/273; 704/E11.001

(57) ABSTRACT

The present invention provides a remote payment system and a method for the same. The remote payment system includes a radio piece, a controller and an input & password verification piece. The controller is electrically connected to the radio piece for recording a credit, and the input & password verification piece respectively coupled the controller and the radio piece, which permits the radio piece to transmit an authorized signal while a correct password is verified.

### FIELD OF THE INVENTION

This invention relates to an electronic payment system and method of the same, and more particularly to a remote payment system and method of the same.

### BACKGROUND OF THE INVENTION

It is generous to use a smart card as a payment mechanism in modern society. The principle of the smart card is emitting a radio signal by a reading device, which will activate the driver circuit inside the smart card, and the smart card will emit another radio signal to response the reading device. The transaction is carried out by the information exchanged in mentioned processes.

From now on, the payment system still develops, and gradually uses a mobile phone as a carrier in the electronic payment system of contactless mode, such as the Felica system provided by Sony electric co. However, the Felica system is just attaching the smart card to the mobile phone, and there is no connection, no matter wire or wireless, between the phone and the smart card, which means the Felica system simply makes use of the habit that modern persons almost take the mobile phone everytime and everywhere, to achieve the purpose of taking the smart card in payment. Further, in order to maintain the transaction security, most of prior arts focus their attention on the security of the data transmission, but there is no concrete tactic in well preventing the smart card embezzlement when the smart card is lost or stolen.

Besides, the owner of the prior smart card can not be sure if the transaction amount is exactly the same as displayed on card reader. What if the card reader request more than it displayed? The owner can not authorize the precise amount in transaction. In order to overcome the deficient, there is another improved electronic payment system provided in the prior art. The steps of the improved system includes: first, a consumer inputs the ID number and mobile phone number thereof into a merchant's inputting device; second, the inputting device transmits a password to the consumer's mobile phone; and finally, the consumer inputs the password to the inputting device to carry out the transaction. Although the improved system is safer than prior one, it works based on that the fraud has no idea about the ID number of the mobile phone owner. In some special cases, the improved system still can be embezzled by the owner's family. In addition, go through the whole steps of the forgoing systems takes a lot of time, which is inconvenient for use of gate passing, tickets buying, or shopping in a convenient store. Moreover, if the mobile phone is in weak signal area, the system will totally not work. Finally, the operation of the improved system is based on signals transmitted between the inputting device and the mobile phone, which needs corporation of several different pieces, and hence is not simple and efficient.

In order to overcome the drawbacks in the prior art, A remote payment system and device of the same is provided. The particular design in the present invention not only solves the problems described above, but also is easy to be implemented. Thus, the invention has the utility for the industry.

### SUMMARY OF THE INVENTION

It is an aspect of the present invention to provide a remote payment system, and the remote payment system includes a radio piece, a controller and a input & password verification piece. The controller is electrically connected to the radio piece for recording a speech, and the input & password verification piece respectively coupled the controller and the radio piece, which permits the radio piece to transmit an authorized signal while a correct password verified.

Preferably, the speech is describing an amount of a money.

Preferably, the input & password verification piece is a speech-recognition piece.

Preferably, the input & password verification piece is configured within a communication device having a microphone, and is electrically connected to the microphone.

Preferably, the input & password verification piece is a processor of the communication device.

Preferably, the radio piece is configured within a communication device.

Preferably, the remote payment system is embedded in a telephone with both the radio piece and the input & password verification piece thereof being configured within the telephone.

Preferably, the input & password verification piece is configured on an access device.

Preferably, the access device has a microphone electrically connected to the input & password verification piece.

Preferably, the remote payment system further includes a copy protection device storing therein a predetermined voice, wherein a user is asked to input a second voice while a first voice inputted thereto is the same with the predetermined voice. Predetermined voice could be raw speech samples or a set of feature parameters.

Preferably, the copy protection device is configured with a communication device.

It is another aspect of the present invention to provide a copy protection device with a predetermined voice, requesting a user to input a second voice while a first voice inputted thereto is the same with the predetermined voice.

Preferably, the copy protection device is applied in a remote payment system.

Preferably, the remote protection device further includes a radio piece, a controller and a speech-recognition piece. The controller is electrically connected to the radio piece for recording an amount of a money, and the speech-recognition piece is respectively coupled to the controller and the radio piece, and permits the radio piece to transmit an authorized signal while a voice verified.

Preferably, the remote payment system is configured with a mobile communication device.

Preferably, the remote payment system is electrically connected to a microphone of the mobile communication device.

It is further another aspect of the present invention to provide a method for implementing a remote payment system, wherein the remote payment system comprise of a radio piece, a controller coupled to the radio piece, and a speech-recognition piece coupled to the controller and the radio piece respectively and having a predetermined voice. The method for implementing the remote payment system includes steps of starting the remote payment system, inputting a voice into the remote payment system, comparing the input voice with the predetermined voice, and authorizing the controller to subtract an amount of a money from a sum when the compared result is correct.

Preferably, the input voice comprising a description of the amount of the money.

Preferably, if the compared result is wrong, the method further includes a step of showing a code and requesting the user to repeat it.

Preferably, the code is one selected from a group consisting of a numeral, a letter, and a combination thereof.

Preferably, the code is randomly generated.

The above aspects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a remote payment system of the present invention;

FIG. 2 is a illustrating diagram according to the first embodiment of the present invention;

FIG. 3 is a illustrating diagram according to the second embodiment of the present invention;

FIG. 4 is a illustrating diagram according to the third embodiment of the present invention;

FIG. 5 is a diagram illustrating the operating principle according to the fourth embodiment of the present invention;

FIG. 6 is a illustrating diagram according to the fifth embodiment of the present invention;

FIG. 7 is a diagram illustrating the another operating principle according to the sixth embodiment of the present invention; and

FIG. 8 is a diagram illustrating the further another operating principle according to the seventh embodiment of the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

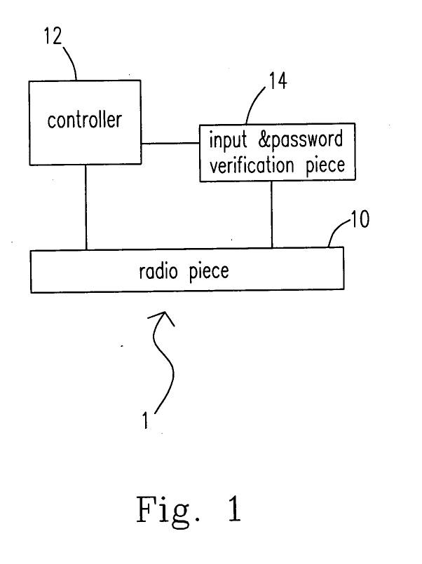

Please refer to FIG. 1, which is a schematic view illustrating a remote payment system of the present invention. The remote payment 1 of the present invention includes a radio piece 10, a controller 12 and an input & password verification piece 14, and these three pieces are connected to each other in wire or in wireless. The controller 12 not only controls the implementation of the remote payment 1 but also stores a amount of money, and the amount of the money comprise (consist?) of a currency name, such as USD, EUR, JPY or GBP, and a sum. In addition, the controller 12 has a ability of making transaction in different currencies by storing different amounts of different currencies or automatically currency exchange with card reader, which is convenient in worldwide travel. Further, the controller 12 can be replaced with a processor, or use a processor as a controller 12. The radio piece 10 is electrically connected to the controller 12, and the function thereof is authorizing the controller 12 to subtract an amount of a money from the sum stored in controller 12 in radio way.

Please continue referring to FIG. 1, the input & password verification piece 14 has an important role in transaction security. In special cases, the input & password verification piece 14 could be a speech-recognition piece, and there is a predetermined voice stored in the speech-recognition piece. The predetermined voice could consist of a single word, a plurality of words, or a plurality of phones having a user's voice-print. For the different predetermined voices, a specific recognition zone will be defined previously. Before authorizing the charge, the user inputs a first voice to the speech-recognition piece by speaking, and then the speech-recognition piece will recognize if input speech is the amount to be paid, and verify the similarity of the first voice with the predetermined voice. If the first voice is recognized and matched to the transaction amount, and falls within the recognition zone, the charge will be allowed, which means the user passes the authorization of the remote payment system. The function of recognition zone can prevent a voice previously recorded or synthesized from passing the authorization of the remote payment system, because these so-called “false voice” described above, no matter how many times they repeat, will have the same or almost the same voice traits, which will not happen in natural human speaking. Therefore, these “false voice” will be identified by the present invention, and the charge will not be authorized. To achieve this purpose, the inputted voices in each transaction can be the predetermined voice in the next time. For example, the inputted first voices of the first to the twentieth transaction, can be the predetermined voice of the twenty-first transaction.

Further, the input & password verification piece 14 could be a keypad having a predetermined password therein, and the user verification can be implemented by using keypad instead of speaking.

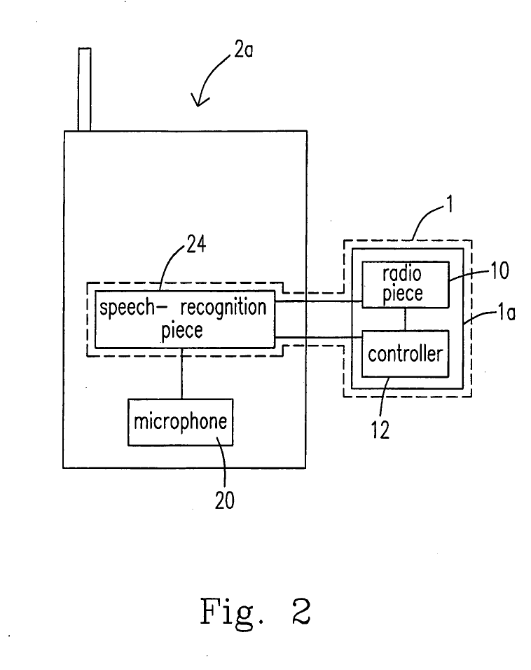

Please refer to FIG. 2, which is a illustrating diagram according to the first embodiment of the present invention. A speech-recognition piece 24 is configured within a first mobile phone 2a having a microphone 20, and is electrically connected to the microphone 20. Therefore a user can input the first voice to the speech-recognition piece 24 via the microphone 20, and the first voice can be recognized/identified in the speech-recognition piece 24. The radio piece 10 and the controller 12 are configured in a first card 1a, and the radio piece 10 and the controller 12 are electrically connected to the speech-recognition piece 24 configured within the first mobile phone 2a. The electrical connection may be a wire connection by metal contacts or a wireless connection within a very close distance, which makes a information could be exchanged between the speech-recognition piece 24 and the first card 1a. The advantages of configuring the speech-recognition piece 24 within the first mobile phone 2a, as showed in FIG. 2, are that the memory and the central processing unit set in the first mobile phone 2a can function as the speech-recognition piece 24. In fact, the computation capability of the mobile phone getting more and more powerful and mobile phone already has microphone and memory, and hence the mobile phone can be implemented as a very sophisticated speech/speaker recognition module with microphone. Therefore, when applying the idea of present invention into the mobile phone, the only thing we need to do is to add on a speech-recognition software. Based on the mention above, the mobile phone having a speech-recognition software disclosed according to the present invention, has the function of speech-recognition, and the mobile phone can work together with the first card 1a, which forms a complete remote payment system that having functions of embezzling and faking resistance according to the present invention.

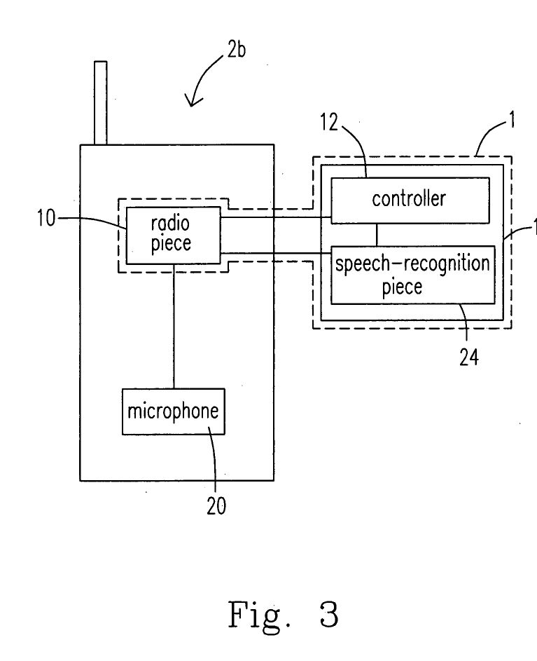

Please refer to FIG. 3, which is a illustrating diagram according to the second embodiment of the present invention. The radio piece 10 is configured within a second mobile phone 2b, and the speech-recognition piece 24 and the controller 12 are configured in a second card 1b. The speech-recognition piece 24 and the controller 12 are electrically connected to the radio piece 10 in contact or not. As the idea has been described in FIG. 2, a wireless communication module that the second mobile phone 2b certainly has, could function as the radio piece 10 that is need in the remote payment according to the second embodiment of the present invention. This kind of design can make use of the electrical pieces of the mobile phone efficiently and saving from configuration of more other pieces. In addition, because both the controller 12 and the speech-recognition piece 24 are configured within the second card 1b, the second card 1b can corporate with any other mobile phone that has an ability of electrical connection therewith and wireless transmission, which forms the remote payment system of the present invention. The characteristic mentioned above is important when the second mobile phone 2b loses power or fails to work. Besides, the second mobile phone 2b also has a microphone 20 that connects electrically to the radio piece 10, and hence a first voice can be input by the microphone 20 and connected electrically to the speech-recognition piece 24 configured in the second card 1b to be speech-recognition/identification.

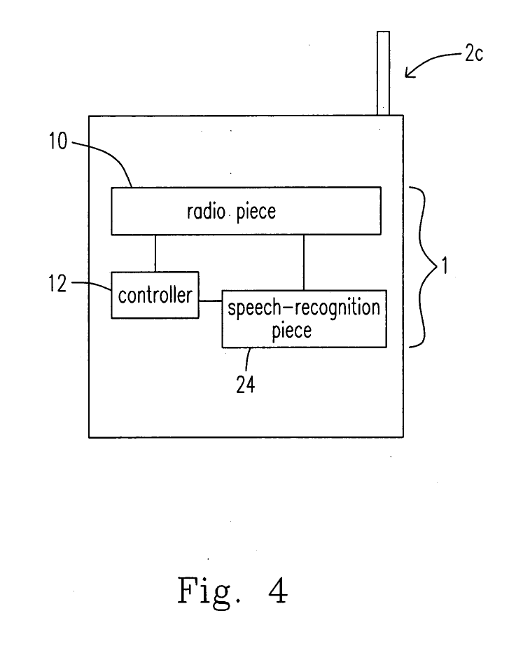

Please refer to FIG. 4, which is a illustrating diagram according to the third embodiment of the present invention. All the pieces disclosed in FIG. 2 are configured within a third mobile phone 2c, which means the pieces already configured within the mobile phone 2c could function as the radio piece 10, the speech-recognition piece 24 and the controller 12 by setting corresponding software in addition. Even the pieces of the remote payment system of the present invention are all additional in stead of the pieces already configured within the mobile phone 2c, the mobile phone 2c is still convenient. The third embodiment showed in FIG. 4 has an advantage that it is not necessary to consider how to exchange the information between the mobile phone and the remote payment system such as showed in FIGS. 2 and 3, because the remote payment system of the present invention has been incorporated within the mobile phone.

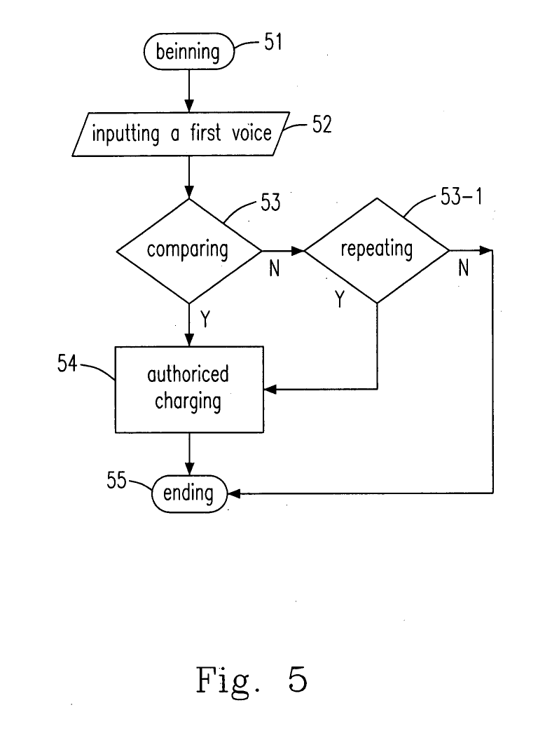

Please refer to FIG. 5, which is a diagram illustrating the operating principle according to the fourth embodiment of the present invention. The remote payment system 1 includes the radio piece 10, the controller 12 electrically connected to the radio piece 10, and the speech-recognition piece 24 electrically connected to the radio 10 and the controller 12, which is showed as FIG. 2. In addition, there is a predetermined voice stored in the speech-recognition piece 24, which is used for speech verification. The steps of the present invention include: the first step, beginning, which is the step of the activation of the remove payment system 51. Usually, the activation of the remote payment is because of the electric wave delivered from the merchant's recipient device being detected by the remote payment system. The second step is to input a first voice to the remote payment system 1, which is the step of inputting a first voice 52, and the first voice is exactly the voice the owner spoke to the remote payment system 1 before. The first voice usually consists of several words of which are the currency name and the transaction amount. The third step is comparing 53 the first voice with the predetermined voice, which means comparing the voice-print of the inputting voice with that of the predetermined voice. In normal cases, the voice of human speaking will not be exactly the same in each time even if the voice is formed from the same words spoke by the same person, and hence if the results of the comparison with first voice are too close, that means the inputted voice is very possible a recorded or a synthesized voice. To avoid this deficiency, there is a recognition zone defined previously based on the predetermined voice. If the inputted voice is a recorded or a synthesized voice, these so-called “false voice” will have the similarity over the recognition zone in compare with the predetermined voice, and if the inputted voice is not spoke by the original user, the similarity will fall below the recognition zone. Only when the comparing result falls within the recognition zone, the system will go to step 4 to authorize the controller 12 to subtract an amount of a money from a sum, which is the step of the authorized charging 54. After the step 4, the sum stored in the controller 12 will decrease and the transaction will be carried out. Further, the first voice can not only function as a password of the remote payment but also can be the indication of the amount of the money subtracted from the sum, such as USD twenty-three or twenty-three USD in the form of the currency name plus the money amount or the money amount plus the currency name. By the voice-recognition/identification, not only the security of the remote payment system is improved but also the transaction amount is specified, which will not prolong the processing time any more. In compare with the present invention, the prior art that uses a short-message delivered by a mobile phone and inputting a password by the button is not only complicated but also take a long time.

Please continue referring to FIG. 5, the remote payment system further includes a step 3-1: if the result of the voice-verification not falls within the recognition zone, the system will provide a random generated code and request the user to repeat 53-1. This code is usually a simple sentence, and the system will compare the voice of the code with the predetermined voice, and if the result falls within the recognition zone, the system will implement the step 4 of authorized charging 54, if not, the system will implement ending 55. After the step 4 of authorized charging 54, the system will also implement ending 55. Based on the mention above, the present invention also provides a copy-protected device that has a predetermined voice. When a inputted voice is identified the same as the predetermined voice, that is identifying result falls over the recognition zone, the user will be requested to input an additional voice. The predetermined voice mentioned above is stored in the speech-recognition piece 24 showed in FIG. 2 to FIG. 4 and FIG. 6, and the voice inputting here is just like the step 2 of inputting the first voice 52 as showed in FIG. 5. If the copy-protected device identifies the inputted voice the same as the predetermined voice, the device will implement the step 3-1 of repeating 53-1 as showed in FIG. 5.

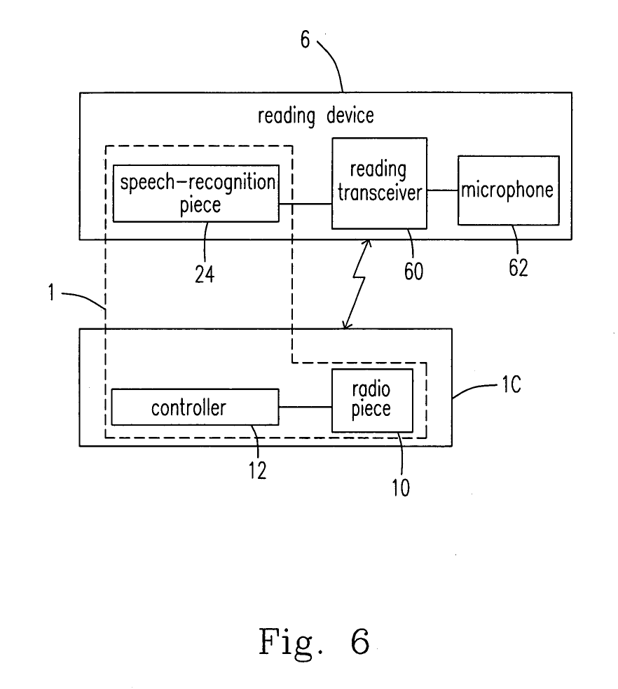

Please refer to FIG. 6, which is a illustrating diagram according to the fifth embodiment of the present invention. The speech-recognition piece 24 of the remote payment 1 according to the present invention is configured in a reading device 6. In addition, a radio transceiver 60 connected electrically to a fixed microphone 62 is configured in the card reader 6. In general, the card reader 6 is set in a certain place such as a merchant or an entrance. The radio piece 10 and the controller 12 are configured in a third card 1c that functions as a gate security card or a remote payment system. A user can input a voice by the fixed microphone 62, and the voice will be identified by the speech-recognition/identification piece 24. If the identifying result falls within the recognition zone, the controller 12 will subtract an amount of a money from the sum, or permitting the entrance if the third card 1c functions as a gate security card. The working steps is just like those described above, which will not be described in detail.

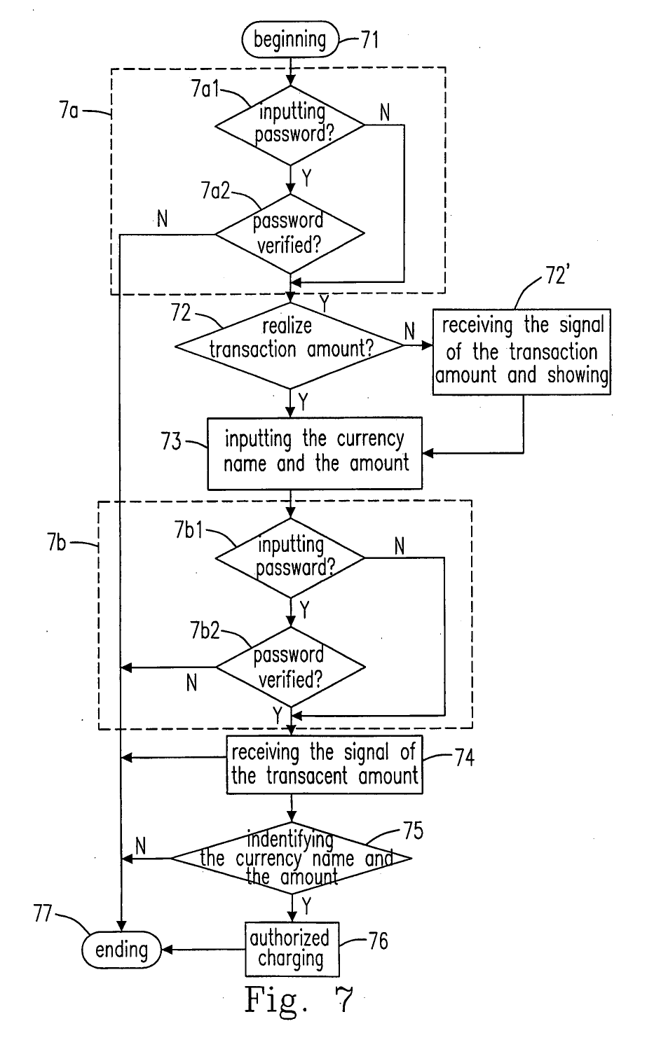

Please refer to FIG. 7, which is a diagram illustrating the another operating principle according to the sixth embodiment of the present invention. The steps showed in FIG. 7 includes: step (1), beginning 71, which means the activation of the remote payment system of the present invention. In general, the remote payment system is activated by a special radio wave from card reader and received by the radio piece 10. The next step (2) is the first verification phase 7a, which is used to verify if the user is exactly the owner. The step (2) includes two stages: the stage (2-1) and the stage (2-2). The stage (2-1) is the first password inputted stage 7a1, which is used to decide if inputting a password and verifying the password in the first verification phase 7a. The stage (2-2) is the first password verified stage 7a2, which is used to verify if the inputted password is correct, when a user decides to verify the password in the first verification phase 7a. In addition, in the first verification phase 7a, the choice of “yes” or “no” in the stage (2-1) of the first password inputting stage 7a1 and the password inputting in the stage (2-2) of the first password verified stage 7a2, can be implemented by speaking or inputting in keypad buttons.

Please continue referring to FIG. 7, if it is needed to input the password in the step (2-1), the system will implement the step (2-2) to verify the inputted password. If the password passes through the verification, the system will implement the step (3) of transaction amount realizing 72, which means the system will query if the user realize the transaction amount, and if the answer is no, the system will implement the step (3-1) of showing the transaction amount received from the merchant by a radio signal. The step (3-1) is the step of receiving the signal of the transaction amount and showing 72′. The next is the step (4) of inputting the currency name and the amount 73, and if the answer to the step (3) is yes, the system will skip the step (3-1) and implement the step (4) directly.

Please refer to FIG. 7, when the step (4) has finished, the step (5) of the second verification phase 7b begins, which is used to verify if the user is the owner. The step (5) includes two stages: the stage (5-1) and the stage (5-2). The stage (5-1) is the second password inputting stage 7b1, which is used to decide if inputting a password and verifying the password in the second verification phase 7b. The stage (5-2) is the second password verification stage 7b2, which is used to verify if the inputted password is correct when a user decides to verify the password in the second verification phase 7b. The next step is step (6) of receiving the signal of the transaction amount 74 in case we didn't do 72′ to get transaction amount, and further is the step (7) of verifying the currency name and the amount 75. If the result of the step (7) is correct, the step (8) of the authorized charging 76 will begin. Final is the step (9) of ending 77, and the whole procedures according to the sixth embodiment of the present invention and the transaction are finished. In addition, in the second verification phase 7b, the choice of “yes” or “no” in the stage (5-1) of the second password inputting stage 7b1 and the password inputting in the stage (5-2) of the second password verification stage 7b2, can be implemented by speaking or inputting in keypad buttons.

The another characteristic of the embodiment showed in FIG. 7 is that the step (2) and the step (5) can be implemented alternatively. For the purpose of security, one of the forgoing two steps will be bound to be implemented. The following is the description in detail.

Please continue referring to FIG. 7, if the password verification is decided to be implemented in step (2) of the first identifying phase 7a, the response to the stage (2-1) of the step (2) must be “yes”, and the password need to be inputted in the stage (2-2). If the password inputted is correct, the system will implement the step (3) of the transaction amount confirmation 72, and the response to the stage (5-1) of the step (5) of the second password inputting stage 7b1 could be “no,” and the system will implement the step (6) of receiving the signal of the 74. The next is the step (7) of identifying the currency name and the amount 75, and if the result of the step (7) is correct, the system will implement the step (8) of authorized charging 76 and final step (9) of ending 77. Instead, if the password verification is implemented in the second verification phase 7b, the response to the stage (2-1) of the step (2) must be “no”, and the system will implement the step (3) of the transaction amount confirmation 72. The next step (5) and followed procedures are the same as those described above. In addition, there is another operating method provided according to the embodiment of the remote payment system of the present invention. When the user decides to be verified in the first verification phase 7a, the system will skip the step (5) and implement the step (6) directly. On the contrary, if the use did not be verified in the first verification phase 7a, the system is forced to implement the stage (5-2) of the second password verification stage 7a2 in the step (5) of the second verification phase 7b, which is used to verify if the password inputted by the user of the remote payment system is correct. The steps followed are the same as described above.

Besides, as showed in FIG. 7, if the password verification fails in the stage (2-2) of the first password verification stage 7a2 or in the stage (5-2) of the second password verification stage 7b2, or the step (6) of receiving the speech signal of the transaction amount 74 takes too time, or the result of the step (7) of verifying the currency name and the amount 75 is wrong, the system will implement the step (9) of ending 77 directly.

Further, the verification both in the step (2) and the step (5) can be implemented by speech/speaker recognition that has been introduced clearly above. Therefore, the user can either use keypad to input transaction amount and authorization password to authorize transaction to perform an authorization transaction. Or just speak the transaction amount to system, and system automatically recognize inputted transaction amount and using voice-print as authorization password to come out authorized transaction by one utterance.

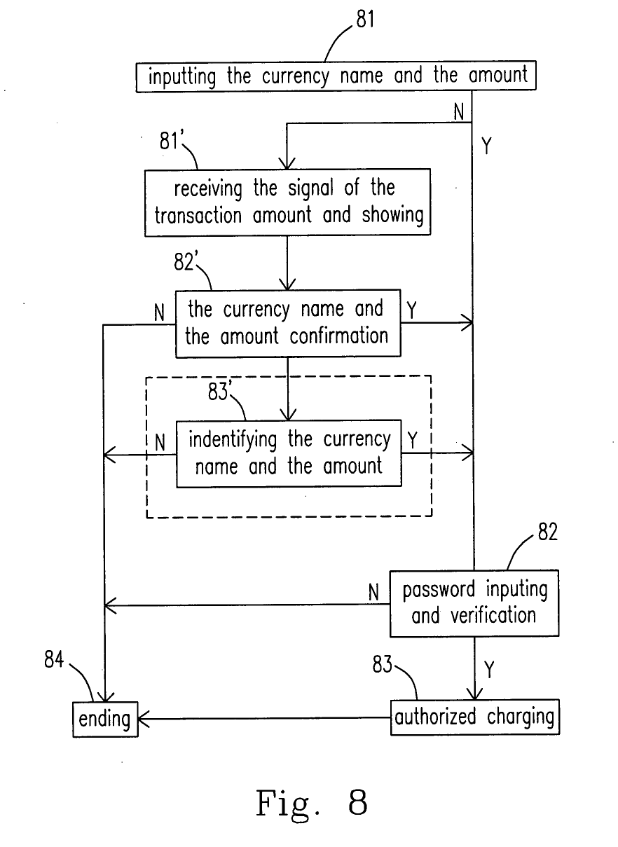

Please refer to FIG. 8, which is a diagram illustrating the further another operating principle according to the seventh embodiment of the present invention. The steps showed in FIG. 8 includes: step (1), inputting the currency name and transaction amount 81, which means the remote payment system is activated by the transaction amount inputting. The currency name and transaction amount can be inputted by speaking or keypad buttons, and then the system will implement the next step (2) of the password inputting and verification 82, which is used to verify if a user is exactly the owner, and the password inputting in the step (2) also can be implemented by speaking or keypad buttons. If the user passes the verification in step (2), the system can directly implement the step (3) of authorized charging. Final is the step (4) of ending 85, and the whole procedures according to the seventh embodiment of the present invention and the transaction are finished.

In addition, if the user didn't make sure the transaction amount, the only thing the user need to do is just make the remote payment system pass through the card reader, and the system will implement the step (1-1) of receiving the signal of the transaction amount and showing 81′. The transaction amount in the step (1-1) is delivered from the merchant by a radio signal. After the system showing the transaction amount, the user has to confirm if the currency name and the amount is right, which means the system will implement the step (1-2) of the currency name and the amount confirmation 82′. The response of the user to the confirmation in the step (1-2) may just be a simple word, such as “Yes”, or a repeating of the currency name and the amount inputted by speaking or keypad buttons. If the confirmation result of the step (1-2) is right, the system will implement the step (2) of the password inputting and verification 82. However, if the user does not pass the confirmation in step (1-2), or the system receives no confirmation signal, the system will implement the step (4) of ending 85. On the contrary, if the user passes the verification of the system in step (2), the system will implement the step (3) of authorized charging and then final step (4) of ending 85, and the whole procedures will also be completed.

For improving transaction safety, if the user identifies the currency name and the amount showed in step (1-1) by repeating the transaction amount in voice, the system will further implement the step (1-3) of identifying the currency name and the amount 83′ to make sure that the user truly realize the transaction amount.

On the contrary, in order to save transaction time, if all inputting and confirmation steps are carried out in speaking, the step (2) of the password inputting and verification 82, the step (1-2) of the currency name and the amount confirmation 82′, and the step (1-3) of identifying the currency name and the amount 83′, can be finished in one step by the speech/speaker recognition technique provided in the present invention and introduced clearly in early description. When the system identifies the currency name and the amount by comparing the user's voice signal and the received signal from the card reader, the user will also be verified by comparing the voice-prints of the inputted voice signal with the basic voice stored in the system previously at the same time. In other words, the system could automatically recognize inputted transaction amount and using voice-print as authorization password to come out authorized transaction by one utterance.

Based on the mention above, the remote payment system of the present invention has a great creativeness in the transaction security and fraud preventing. The creativeness of the present invention is based on that the transaction amount will be inputted by a first voice, and the remote payment system will identify the first voice to confirm if the user is the real owner. In addition, in order to prevent a voice recorded previously by a fraud from confusing the verification, the remote payment system of the present invention provides another protecting mechanism. If the first voice inputted is too similar with a predetermined voice stored in the remote payment system previously, the remote payment system of the present invention will ask the user to input a second voice to be verified. The phrase “too similar” here means the identification result falls over a recognition zone that defined based on the predetermined voice stored in the remote payment system. The identification results can roughly be divided into three types: within the recognition zone, below the recognition zone and over the recognition zone. If the identification results falls below the recognition zone, the remote payment system will recognize the inputted voice as a wrong voice and implement the step of ending directly. If the identification result falls over the recognition zone, which means the inputted voice is almost the same with the predetermined voice, the system will recognize the inputted voice as a recorded or synthesized voice, and also implement the step of ending directly. In another embodiment, the remote payment system will implement the step of password identifying before authorized charging or inputting the transaction amount, to make sure that the user is the real owner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A remote payment system, comprising:
a radio piece;
a controller electrically connected to the radio piece for recording a credit; and
an input & password verification piece respectively coupled the controller and the radio piece, and permitting the radio piece to transmit an authorized signal while a correct password verified.

2. A remote payment system as claimed in claim 1, wherein the credit is an amount of a money.

3. A remote payment system as claimed in claim 1, wherein the input & password verification piece is a speech-recognition piece.

4. A remote payment system as claimed in claim 1, wherein the input & password verification piece is configured within a communication device having a microphone, and is electrically connected to the microphone.

5. A remote payment system as claimed in claim 4, wherein the input & password verification piece is a processor of the communication device.

6. A remote payment system as claimed in claim 1, wherein the radio piece is configured within a communication device.

7. A remote payment system as claimed in claim 1, wherein the remote payment system is embedded in a telephone with both the radio piece and the input & password verification piece thereof being configured within the telephone.

8. A remote payment system as claimed in claim 1, wherein the input & password verification piece is configured on an access device.

9. A remote payment system as claimed in claim 8, wherein the access device has a microphone electrically connected to the input & password verification piece.

10. A remote payment system as claimed in claim 1, further comprising a copy protection device storing therein a predetermined voice, wherein a user is asked to input a second voice while a first voice inputted thereto is the same with the predetermined voice.

11. A remote payment system as claimed in claim 10, wherein the copy protection device is configured with a communication device.

12. A copy protection device with a predetermined voice, requesting a user to input a second voice while a first voice inputted thereto is the same with the predetermined voice.

13. A copy protection device as claimed in claim 12, wherein the copy protection device is applied in a remote payment system.

14. A copy protection device as claimed in claim 12, wherein the remote protection device further comprises:
a radio piece;
a controller electrically connected to the radio piece for recording an amount of a money; and
a speech-recognition piece respectively coupled to the controller and the radio piece, and permitting the radio piece to transmit an authorized signal while a voice verified.

15. A copy protection device as claimed in claim 13, wherein the remote payment system is configured with a mobile communication device.

16. A copy protection device as claimed in claim 15, wherein the remote payment system is electrically connected to a microphone of the mobile communication device.

17. A method for implementing a remote payment system, wherein the remote payment system comprises a radio piece, a controller coupled to the radio piece, and a speech-recognition piece coupled to the controller and the radio piece respectively and having a predetermined voice, comprising steps:
(1) starting the remote payment system;
(2) inputting a voice into the remote payment system;
(3) comparing the input voice with the predetermined voice; and
(4) authorizing the controller to subtract an amount of a money from a sum when the compared result of step (3) is correct.

18. A method as claimed in claim 17, wherein the input voice comprising a reporter of the amount of the money.

19. A method as claimed in claim 17, wherein if the compared result of step (3) is wrong, the method further comprises a step of showing a code and requesting the user to repeat it.

20. A method as claimed in claim 19, wherein the code is one selected from a group consisting of a numeral, a letter, and a combination thereof.

21. A method as claimed in claim 19, wherein the code is randomly generated.
